(19) United States
(12) Patent Application Publication
(10) Pub. No.: US 2008/0118794 A1
(43) Pub. Date: May 22, 2008

(54) FUEL PROCESSOR HAVING IMPROVED STRUCTURE FOR RAPID HEATING UP OF CARBON MONOXIDE REMOVING UNIT AND METHOD OF OPERATING THE FUEL PROCESSOR

(75) Inventors: Hyun-chul LEE, Yongin-si (KR); Soon-ho Kim, Seoul (KR); Doo-hwan Lee, Suwon-si (KR); Kang-hee Lee, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/837,121

(22) Filed: Aug. 10, 2007

(30) Foreign Application Priority Data
Nov. 21, 2006 (KR) 2006-115450

(51) Int. Cl. H01M 8/06; H01M 8/18

(52) U.S. Cl. 429/17; 429/19; 429/20

(57) ABSTRACT

A fuel processor having an improved structure to rapidly increase a temperature of a CO removing unit to an operation temperature, and a method of operating the fuel processor, includes a reformer that produces hydrogen gas by reacting a fuel and water; a CO removing unit that removes CO from the hydrogen produced in the reformer. The CO removing unit comprises a CO shift reactor including a first catalyst that catalyzes a reaction between steam and CO and a second catalyst that catalyzes a reaction between oxygen and CO and between hydrogen and oxygen, and a CO remover including a third catalyst that catalyzes a reaction between oxygen and CO; and an air supply unit that supplies air to the CO shift reactor and the CO remover. The use of the fuel processor can greatly reduce a warming up time required to reach a normal operation of the fuel processor since the CO shift reactor can be rapidly heated using a direct reaction between oxygen and CO and between oxygen and hydrogen during an initial start up operation.

### CROSS-REFERENCE TO RELATED PATENT APPLICATIONS

This application claims the benefit of Korean Patent Application No. 2006-115450, filed Nov. 21, 2006, in the Korean Intellectual Property Office, the disclosure of which is incorporated herein in its entirety by reference.

### BACKGROUND OF THE INVENTION

1. Field of the Invention

Aspects of the present invention relate to a fuel processor that reforms a fuel suitable for use in a fuel cell, and more particularly, to a fuel processor having an improved structure for rapid heating up of a CO removing unit and a method of operating the same.

2. Description of the Related Art

A fuel cell is an electricity generator that changes chemical energy of a fuel into electrical energy through a chemical reaction. A fuel cell can continuously generate electricity as long as the fuel is supplied thereto. FIG. 1 is a schematic drawing illustrating the energy transformation structure of a conventional unit cell. Referring to FIG. 1, when air that includes oxygen is supplied to a cathode 1 and a fuel containing hydrogen is supplied to an anode 3, electricity is generated as an electrolyte membrane 2 allows hydrogen ions to flow from the anode 3 to the cathode 1 through the electrolyte membrane 2 while electrons e are forced to flow through a circuit, which produces usable energy. Generally, electricity is generated by a fuel cell stack in which a plurality of unit cells 4 is connected in series as each unit cell 4, as illustrated in FIG. 1, does not produce a voltage high enough to be useful.

A hydrocarbon group containing material, such as a natural gas, is used as a fuel source to supply hydrogen to the fuel cell stack. Hydrogen is derived from the fuel source by a fuel processor 10, as depicted in FIG. 2, and is supplied to a stack 20.

The fuel processor 10 includes a desulfurizer 11, a reformer 12, a burner 13, a water supply pump 16, first and second heat exchangers 14a and 14b, and a carbon monoxide (CO) removing unit 15 including a CO shift reactor 15a and a CO remover 15b. The hydrogen extraction process is performed in the reformer 12. That is, hydrogen is generated through Chemical Reaction 1, as indicated below, between a hydrocarbon group gas, which is the fuel source entering from a fuel tank 17, and steam, which is generated from water supplied from a water tank 18 by the water supply pump 16. The water from the water tank 18 is turned to steam by passing through the first and second heat exchangers 14a and 14b before entering the reformer 18.

CH₄+2H₂O→CO₂+4H₂ [Chemical Reaction 1]

However, at this time, CO is generated together with CO₂ as a byproduct. If a fuel containing 10 ppm or more of CO is supplied to the stack 20, the electrodes (the anode 3 and the cathode 1 from FIG. 1 above) of the fuel cell are poisoned resulting in a rapid reduction of the performance of the fuel cell. Therefore, the content of CO in the fuel at an outlet of the reformer 12 is controlled to be 10 ppm or less by installing the CO shift reactor 15a and the CO remover 15b.

A Chemical Reaction 2, as indicated below, occurs in the CO shift reactor 15a, and Chemical Reactions 3, 4, and 5, as indicated below, occur in the CO remover 15b. The CO content in the fuel that has passed through the CO shift reactor 15a is 5,000 ppm or less, and the CO content in the fuel that has passed through the CO remover 15b is reduced to 10 ppm or less. A first catalyst, such as Cu/ZnO/Al₂O₃, a Pt group, or an Au group that catalyzes the Chemical Reaction 2, involving steam, is included in the CO shift reactor 15a, and a second catalyst, such as a Pt group, an Ru group, or an Au group that catalyzes the Chemical Reaction 3, involving oxygen, is included in the CO removing unit 15b.

CO+H₂O→CO₂+H₂ [Chemical Reaction 2]

CO+½O₂→CO₂ [Chemical Reaction 3]

H₂+½O₂→H₂O [Chemical Reaction 4]

CO+3H₂→CH₄+H₂O [Chemical Reaction 5]

The desulfurizer 11, located at an inlet of the reformer 12, removes sulfur components contained in the fuel source. The sulfur components are absorbed while passing through the desulfurizer 11 because the sulfur components can easily poison the electrodes of the fuel cell stack if even 10 parts per billion (ppb) or more of the sulfur components are supplied to the stack 20.

When the fuel processor 10 is operating, a fuel source, such as a natural gas, is supplied to the reformer 12 through the desulfurizer 11 from the fuel tank 17. A portion of the fuel source is used as a fuel for igniting the burner 13. Then, steam that has entered through the first and second heat exchangers 14a and 14b reacts with the desulfurized fuel in the reformer 12, and thus hydrogen is generated. Then, the generated hydrogen is supplied to the stack 20 after the CO content is reduced to 10 ppm or less by the CO shift reactor 15a and the CO remover 15b.

However, when the fuel processor 10 starts operating, the reformer 12 and the CO shift reactor 15a are at room temperature, which is insufficient to produce hydrogen from the fuel and remove the CO from the produced hydrogen. Therefore, normal operation of the fuel processor 10 cannot be achieved instantly, but only after a period of time in which the fuel processor 10 is heated, the normal operation is possible. However, the CO shift reactor 15a also needs to be heated. That is, the temperature of the reformer 12 can be increased in a short period of time as the reformer 12 is directly heated by the burner 13. However, the CO shift reactor 15a is indirectly heated by gases entering from the reformer 12, and as such, the CO shift reactor 15a requires time to reach a normal operating temperature. Generally, a normal operating temperature of the reformer 12 is 700° C., and a normal operating temperature of the CO shift reactor 15a is 200° C. It takes approximately 20 minutes for the reformer 12 to reach 700° C. after starting operation, but the CO shift reactor 15a requires approximately one hour to reach 200° C. Accordingly, although the reformer 12 can rapidly reach the normal operating temperature, the fuel processor 10 is unable to operate until the CO shift reactor 15a reaches the normal operating temperature. In other words, a hydrogen gas can be produced in the reformer 12 in approximately 20 minutes after the fuel processor 10 starts operating, but in order to reduce the CO content in the gas to below 5,000 ppm, the fuel processor 10 must wait for about an hour to begin operation.

Accordingly, in order to reduce the time required to reach a normal operation of the fuel processor 10 after starting an operation, there is a need to develop a system that can rapidly heat the CO shift reactor 15a.

### SUMMARY OF THE INVENTION

Aspects of the present invention provide a fuel processor having an improved warming structure that can greatly reduce an initial heating time for a CO removing unit and a method of operating the same.

According to an aspect of the present invention, there is provided a fuel processor comprising: a reformer to produce a hydrogen gas by reacting a fuel and water; a CO removing unit that removes CO from the hydrogen gas, and the CO removing unit comprises a CO shift reactor including a first catalyst that catalyzes a reaction between steam and CO and a second catalyst that catalyzes a reaction between oxygen and CO and between hydrogen and oxygen and a CO remover including a third catalyst that catalyzes a reaction between oxygen and CO; and an air supply unit to supply air to the CO shift reactor and the CO remover.

In the CO shift reactor, the second catalyst may be concentrated at an inlet of the CO shift reactor. The first catalyst may be at least one selected from the group consisting of Cu/ZnO/Al₂O₃, Fe/Cr oxide, metal oxides, a Pt group catalyst, and an Au group catalyst, and the second catalyst and the third catalyst may be each independently at least one selected from the group consisting of metal oxides, Pt, Ru, and Au. The air supply unit may comprise an air supply line to connect an air supply source to the CO shift reactor and to the CO remover and valves to control the supplying of the air to the CO shift reactor and to the CO remover.

According to an aspect of the present invention, there is provided a method of operating the fuel processor to generate hydrogen gas to be supplied to a fuel cell stack by a reaction between a fuel and water in a reformer which is heated by a burner, and a CO component of the generated hydrogen gas is removed by a CO removing unit that comprises a CO shift reactor and a CO remover, the method comprising: preparing the CO removing unit by filling a first catalyst that catalyzes a reaction between steam and CO and a second catalyst that catalyzes a reaction between oxygen and CO in the CO shift reactor and by filling a third catalyst that catalyzes a reaction between oxygen and CO in the CO remover; generating a reaction between oxygen and CO which is catalyzed by the second catalyst by supplying the hydrogen gas from the reformer and air to the CO shift reactor and the CO remover when the temperature of the reformer reaches a first temperature during an initial start up mode; and shifting to a normal operation mode by supplying hydrogen gas that has passed through the CO remover to the fuel cell stack after stopping the supply of air to the CO shift reactor when the temperature of the CO shift reactor reaches a second temperature.

The normal operation temperature of the reformer may be 500° C. The normal operation temperature of the CO shift reactor may be 200° C.

An amount of air supplied to the CO shift reactor may be between about 0.05 to 5 times the volume of the CO in the hydrogen gas.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic drawing illustrating a conventional unit cell;

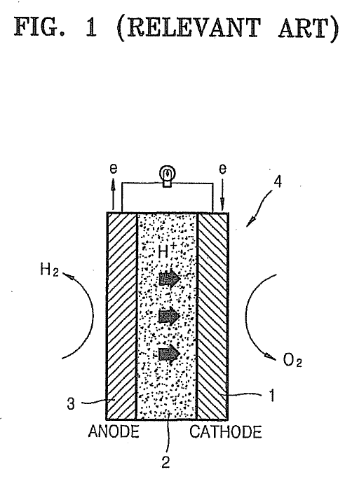

FIG. 2 is a block diagram of a conventional fuel processor that processes a fuel to be supplied to a fuel cell;

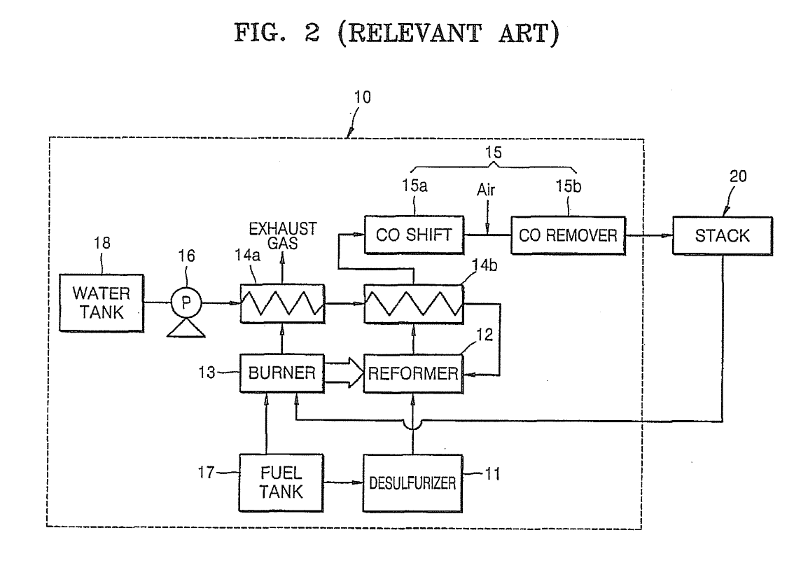

FIG. 3 is a block diagram of a fuel processor according to aspects of the present invention;

FIG. 4 is a schematic drawing illustrating a structure of a CO removing unit of the fuel processor of FIG. 3, according to aspects of the present invention; and

FIGS. 5A and 5B show graphs of an internal temperature of a CO shift reactor and the concentration change of components of a gas, respectively, when the fuel processor of FIG. 3 is started operation.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

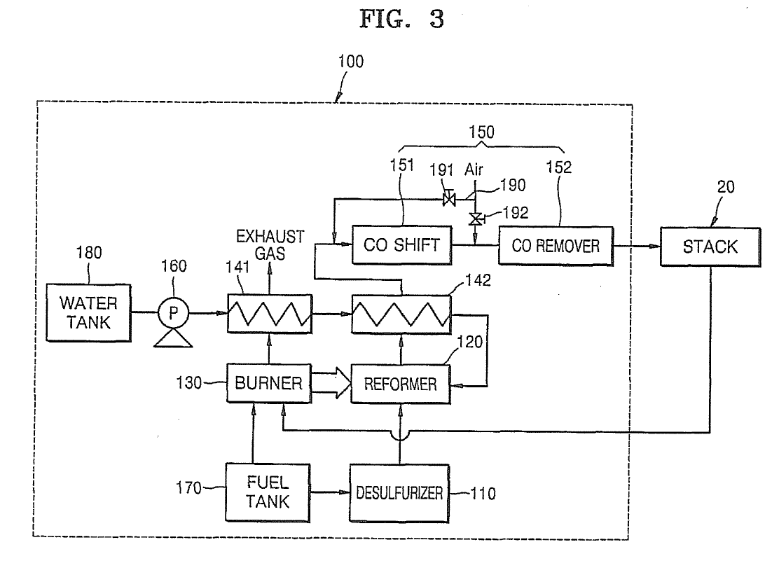

FIG. 3 is a block diagram of a fuel processor 100 according to aspects of the present invention. The fuel processor 100 includes a desulfurizer 110, a reformer 120, a burner 130, and a CO removing unit 150, which comprises a CO shift reactor 151 and a CO remover 152. The fuel processor 100 has a basic structure in which a raw gas, such as natural gas, is supplied from a fuel tank 170. Sulfur components included in the raw gas are removed by adsorption in the desulfurizer 110, and hydrogen that is to be supplied to a stack 20 is produced in the reformer 120 by reacting the raw gas with the steam, which is generated from water supplied by a water supply pump 160 from a water tank 180. The CO shift reactor 151 decreases the amount of CO in the hydrogen produced in the above process to an amount of 5000 ppm or less, and the CO remover 152 decreases the amount of CO in the hydrogen to an amount of 10 ppm or less. First and second heat exchangers 141 and 142 preheat the water supplied by the water pump 160 to the reformer 120 from the water tank 180.

The fuel processor 100, according to aspects of the current invention, includes a structure that can rapidly heat the CO shift reactor 151 so that the fuel processor 100 can reach normal operation in a short period of time after starting the fuel processor.

That is, the fuel processor 100 includes an air supply line 190 and valves 191 and 192 so that air is supplied to the CO remover 152 of the CO removing unit 150 and to the CO shift reactor 151. That is, the fuel processor 100 has a structure in which air can be supplied to the CO shift reactor 151, if necessary. As such, the air supply line 190 supplies air to inlet lines of the CO shift reactor 151 and the CO remover 152 through the valves 191 and 192. The valves 191 and 192 control whether the air is supplied to the CO shift reactor 151 and the CO remover 152.

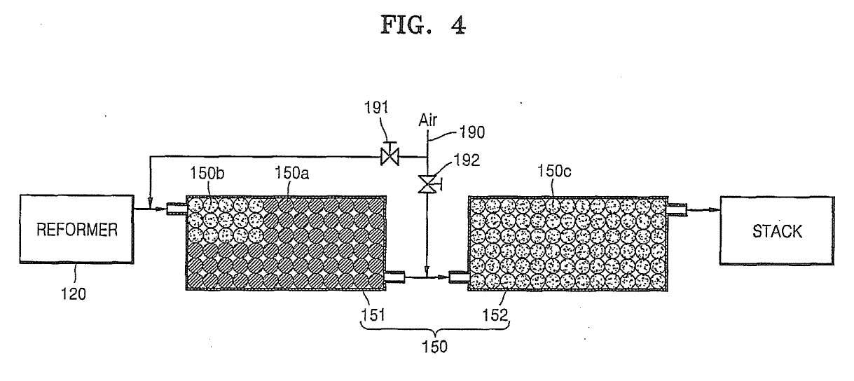

FIG. 4 is a schematic drawing illustrating a structure of a CO removing unit of the fuel processor of FIG. 3, according to aspects of the present invention. Referring to FIG. 4, a first catalyst 150a, which catalyzes a reaction between steam and CO, together with a second catalyst 150b, which catalyzes a reaction between oxygen and CO, are included in the CO shift reactor 151. Generally, in the CO shift reactor 151, CO is transformed into CO₂ by reacting CO with steam using the first catalyst 150a that catalyzes the reaction between steam and CO. And, in the CO remover 152, CO is transformed into CO₂ by directly reacting CO with oxygen using a third catalyst 150c that catalyzes a reaction between oxygen and CO.

The second catalyst 150b that catalyzes a direct reaction between oxygen and CO is included at an inlet of the CO shift reactor 151, i.e., the second catalyst 150b is arranged in the CO shift reactor 151 near the inlet through which the hydrogen produced from the reformer 120 and the air supplied from the air supply line 190 through the valve 191 enter the CO shift reactor 151. Arranging the second catalyst 150b near the inlet of the CO shift reactor 151 can rapidly increase the internal temperature of the CO shift reactor 151 from an ambient temperature by catalyzing an exothermic reaction between CO and oxygen (Chemical Reaction 3) when a rapid temperature increase is required. Further, the second catalyst 150b can catalyze an exothermic reaction between hydrogen and oxygen (Chemical Reaction 4) to increase the temperature of the CO shift reactor. That is, when the fuel processor 100 is required to quickly enter a normal operational state, the exothermic chemical reactions (Chemical Reactions 3 and 4) can heat the CO shift reactor 151 quickly from the ambient temperature. Heat produced by the reaction between CO and oxygen (Chemical Reaction 3) is 67.6 kcal/mol, and heat produced by the reaction between hydrogen and oxygen (Chemical Reaction 4) is 58.6 kcal/mol. Heat produced by the reaction between CO and steam (Chemical Reaction 2) is only about 20 kcal/mol. Thus, the second catalyst 150b disposed near the inlet of the CO shift reactor 151 can increase the temperature in the CO shift reactor 151 about three times as fast as the first catalyst 150a alone. Also, the concentration of the second catalyst 150b near the inlet of the CO shift reactor 151 rapidly increases the temperature of the CO shift reactor 151 as air entering into the CO shift reactor 151 directly reacts with the second catalyst 150b. Experimentally, it has been demonstrated that the reaction between CO and oxygen mostly occurs in a front portion of the catalyst layer. Therefore, the concentration of the second catalyst 150b near the inlet of the CO shift reactor 151, where the air enters, is effective for increasing temperature of the CO shift reactor 151.

The first catalyst 150a can be at least one of Cu/ZnO/Al₂O₃, Fe/Cr oxide, a metal oxide, a Pt group, Au group. The second and third catalysts 150b and 150c can be at least one of metal oxides, Pt, Ru, and Au. The second and third catalyst 150b and 150c can be the same catalyst.

During normal operation, the air supply to the CO shift reactor 151 is stopped, and then, a reaction between CO and steam that is catalyzed by the first catalyst 150a occurs in the CO shift reactor 151 and a reaction between CO and oxygen that is catalyzed by the third catalyst 150c occurs in the CO remover 152. During normal operation, CO can also be removed by supplying air to the CO shift reactor 151. However, supplying air to the CO shift reactor 151 during normal operation may oxidize the hydrogen that is to be supplied to the stack 20. Accordingly, during normal operation, a large amount of CO is removed from the hydrogen produced by the reformer 120 by reaction with steam in the CO shift reactor 151, and the CO content in the hydrogen gas is reduced from 5,000 ppm to 10 ppm or less by reaction with oxygen in the CO remover 152.

Operation of the fuel processor 100 is described with reference to FIG. 3. When the fuel processor 100 is started, the fuel processor 100 is started in a rapid heating mode as the reformer 120 and the CO shift reactor 151 are at a relatively cool, ambient temperature.

First, the temperature inside the reformer 120 is increased by igniting the burner 130. As the reformer 120 is directly heated by the burner 130, the burner 130 heats the reformer to a temperature of about 700° C., which is a normal operating temperature of the reformer 120, in approximately 20 minutes.

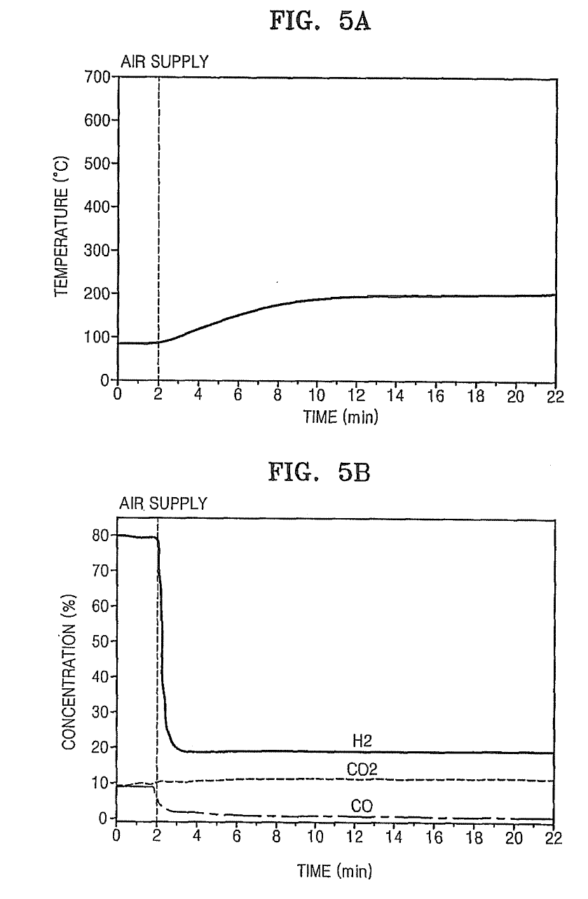

However, when the temperature inside the reformer 120 reaches approximately 500° C., a hydrocarbon gas, which is a fuel source, and water are supplied to the reformer 120. The reformer 120 reaches a temperature of 500° C. in about 5 to 10 minutes after the ignition. The temperature of the reformer 120 continuously increases due to heating by the burner 130, and hydrogen gas is produced by a reaction (Chemical Reaction 1) between the water and hydrocarbon gas in the reformer 120. Gas reformed in the reformer 120 sequentially passes through the CO shift reactor 151 and the CO remover 152 of the CO removing unit 150, and, at this point, the valves 191 and 192 are opened to supply air to both the CO shift reactor 151 and the CO remover 152. Then, an active exothermic reaction occurs between the reformed gas containing CO and hydrogen gas that enters into the CO shift reactor 151 and oxygen in the air. The reformed gas that has passed through the reformer 120 generally contains 80% hydrogen, 10% CO, and 10% CO₂. Accordingly, the main exothermic reaction is between hydrogen and oxygen. At this point, as depicted in FIG. 5B, it was measured that approximately 75% of the hydrogen gas is oxidized in the exothermic reaction and approximately 20% of the hydrogen gas remains. Accordingly, as described above, air is supplied from the air supply line 190 through the valve 191, so that the exothermic reaction occurs in the CO shift reactor 151 in an initial starting mode. That is, when a rapid temperature increase is necessary air is supplied to the CO shift reactor 151. And, during a normal operation mode, the oxidation reaction of CO with oxygen is performed in the CO remover 152. CO also is removed by oxidizing in the exothermic reaction. As shown in FIG. 5B, approximately 10 minutes after the exothermic reaction starts, CO content in the gas that has passed through the CO shift reactor 151 is reduced to about 5000 ppm, which is a level of CO content that can be supplied to the CO remover 152. The CO content level reaches a normal operation level after about 10 minutes of operation, and the temperature reaches 200° C., which is a normal operation temperature, after approximately 20 minutes. Accordingly, approximately 20 minutes after the fuel processor 100 starts, the temperature of the CO shift reactor 151 reaches a level at which the operation of the fuel processor 100 can be shifted into a normal operation mode. The temperature as shown in FIG. 5A indicates the temperature as measured in the center of the CO shift reactor 151.

The operation can be shifted to a normal operation mode when the internal temperature of the CO shift reactor 151 reaches 200° C. due to exothermic reactions as catalyzed by the second catalyst 150b. During the normal operation mode, as described above, air supply to the CO shift reactor 151 is stopped by controlling the valve 191 while air is supplied only to the CO remover 152 through the valve 192. In the CO shift reactor 151, CO contained in the reformed gas generated by the reformer 120 is removed by a reaction with hydrogen, and CO is removed by a direct reaction with oxygen in the CO remover 152. Hydrogen gas from which CO is removed is supplied to the stack 20, and thus, a normal operation of a fuel cell is achieved.

An amount or air supplied to the CO shift reactor 151 during a start mode may be 0.05 to 5 times the volume of CO. That is, an amount of air that can generate a smooth exothermic reaction to oxidize CO and hydrogen is supplied. If air is supplied in excess, the hydrogen may be exhausted. Therefore, the supply of air may be controlled not to exceed five times the volume of CO. Approximately 10% of the reformed gas entering into the CO remover 152 is CO. The supply of air can be smoothly controlled when the flowrate of the reformed gas and the flowrate of the air are set in the above range.

When a fuel processor is operated as described above, a normal operation is possible approximately 20 minutes after starting operation of the fuel processor. Therefore, the time necessary to begin operation of a fuel cell can be greatly reduced compared to relevant art, which takes at least one hour to supply hydrogen to a stack after start up of the fuel processor. In other words, a fuel processor that can greatly reduce the time necessary to reach a normal operation of the fuel processor and a fuel cell system having the fuel processor can be realized.

A fuel processor according to aspects of the present invention has at least the following and/or other advantages. First, a rapid heating of a CO shift reactor during start up can be realized using a direct reaction between oxygen and hydrogen. Therefore, the time required for the fuel processor to reach a normal operation can be greatly reduced. Second, as the time for start up is greatly reduced, the time necessary for restarting the fuel processor after operation of the fuel processor is stopped for a period of time, for example, to perform a maintenance work is also greatly reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel processor, comprising:
a reformer to produce a hydrogen gas by reacting a fuel and water;
a CO removing unit that removes CO from the hydrogen gas, and the CO removing unit comprises:
a CO shift reactor including a first catalyst that catalyzes a reaction between steam and CO, and a second catalyst that catalyzes a reaction between oxygen and CO and between hydrogen and oxygen; and
a CO remover including a third catalyst that catalyzes a reaction between oxygen and CO; and
an air supply unit to supply air to the CO shift reactor and the CO remover.

2. The fuel processor of claim 1, wherein, in the CO shift reactor, the second catalyst is concentrated at an inlet of the CO shift reactor.

3. The fuel processor of claim 1, wherein the first catalyst is at least one selected from the group consisting of Cu/ZnO/Al₂O₃, Fe/Cr oxide, metal oxides, a Pt group catalyst, and an Au group catalyst; and the second catalyst and the third catalyst are each independently at least one selected from the group consisting of metal oxides, Pt, Ru, and Au.

4. The fuel processor of claim 1, wherein the air supply unit comprises:
an air supply line to connect an air supply source to the CO shift reactor and to the CO remover; and
valves to control the supplying of the air to the CO shift reactor and to the CO remover.

5. A method of operating a fuel processor to generate hydrogen gas to be supplied to a fuel cell stack by a reaction between a fuel and water in a reformer, which is heated by a burner, and a CO component of the generated hydrogen gas is removed by a CO removing unit that comprises a CO shift reactor and a CO remover, the method comprising:
preparing the CO removing unit by filling a first catalyst that catalyzes a reaction between steam and CO and a second catalyst that catalyzes a reaction between oxygen and CO in the CO shift reactor and by filling a third catalyst that catalyzes a reaction between oxygen and CO in the CO remover;
generating a reaction between oxygen and CO which is catalyzed by the second catalyst by supplying the hydrogen gas from the reformer and air to the CO shift reactor and the CO remover when the temperature of the reformer reaches a first temperature during an initial start up mode; and
shifting to a normal operation mode by supplying hydrogen gas that has passed through the CO remover to the fuel cell stack after stopping the supply of the air to the CO shift reactor when the temperature of the CO shift reactor reaches a second temperature.

6. The method of claim 5, wherein the first temperature is 500° C.

7. The method of claim 5, wherein the second temperature is 200° C.

8. The method of claim 5, wherein an amount of air supplied to the CO shift reactor is between about 0.05 to 5 times the volume of the CO in the hydrogen gas.

9. A fuel cell system comprising the fuel processor of claim 1.

10. A fuel processor for a hydrogen fuel cell, comprising:
a reformer to produce a hydrogen gas;
a CO removing unit to decrease an amount of CO present in the hydrogen gas to below 10 ppm, the CO removing unit comprising:
a CO shift reactor including a first catalyst and a second catalyst; and
a CO remover comprising a third catalyst,
wherein the second catalyst catalyzes an exothermic reaction when air is supplied thereto to heat the CO shift reactor to an operation temperature; and
an air supply unit to supply the air to the CO removing unit,
wherein the CO shift reactor heats to the operation temperature from an ambient temperature in about 20 minutes or less.

11. The fuel processor of claim 10, wherein the CO shift reactor comprises an inlet through which the hydrogen gas from the reformer and the air from the air supply unit enters the CO shift reactor,
wherein the second catalyst is disposed near the inlet of the CO shift reactor.

12. The fuel processor of claim 10, wherein the second catalyst and the third catalyst are the same catalyst.

13. The fuel processor of claim 10, wherein the air unit supplies the air to the CO shift reactor to heat the CO shift reactor to reach the operation temperature but does not supply air thereto during a normal operation of the CO shift reactor.

14. The fuel processor of claim 10, wherein the operation temperature of the CO shift reactor is about 200° C.

15. A CO removing unit, comprising:
a CO shift reactor to decrease an amount of CO in a hydrogen gas supplied thereto, the CO shift reactor including a first catalyst and a second catalyst;
a CO remover to further decrease the amount of CO in the hydrogen gas to below about 10 ppm, the CO remover including a third catalyst; and
an air supply unit to supply air to the CO shift reactor and the CO remover,
wherein the air supply unit supplies air to the CO shift reactor to heat the CO shift reactor to an operation temperature through an exothermic reaction between the air and CO as catalyzed by the second catalyst.

16. The CO removing unit of claim 15, wherein the air is mixed with the hydrogen gas before entering the CO shift reactor.

17. The CO removing unit of claim 15, wherein the CO shift reactor is heated through an exothermic reaction between hydrogen in the hydrogen gas and oxygen in the air as catalyzed by the second catalyst.

18. A CO removing unit, comprising:
a CO shift reactor including a catalyst, and the CO shift reactor decreases an amount of CO in a hydrogen gas supplied thereto;
a CO remover to further decrease the amount of CO in the hydrogen gas to below about 10 ppm; and
wherein air is supplied to the CO shift reactor to heat the CO shift reactor to an operation temperature through an exothermic reaction between oxygen in the air and CO in the hydrogen gas as catalyzed by the catalyst.

19. A method of operating a fuel processor to produce hydrogen having less than 10 ppm of CO, the method comprising:
if a temperature of a CO shift reactor of the fuel processor is less than an operation temperature, supplying air to the CO shift reactor to heat the CO shift reactor to the operation temperature through an exothermic reaction between oxygen in the supplied air and CO in a hydrogen gas as catalyzed by a catalyst in the CO shift reactor; and
if the temperature of the CO shift reactor is at or greater than the operation temperature, stopping the supply of the air to the CO shift reactor.
